(19) United States
(12) Patent Application Publication
(10) Pub. No.: US 2009/0170217 A1
(43) Pub. Date: Jul. 2, 2009

(54) DEVICE FOR SAMPLE PRETREATMENT, REACTOR SHEET, AND METHOD OF SAMPLE ANALYSIS

(76) Inventors: Yukie SASAKURA, Minamiashigara (JP); Tsuyoshi Ogino, (US)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/323,490

(22) Filed: Nov. 26, 2008

(30) Foreign Application Priority Data
Nov. 26, 2007 (JP) 2007-304905

(51) Int. Cl. G01N 1/18; B01J 19/00

(52) U.S. Cl. 436/178; 422/68.1

(57) ABSTRACT

An object of the present invention is to introduce a sample solution into the minute and hydrophobic inside of a reactor for a pretreatment while avoiding bubble formation. According to the present invention, a reactor that has at least one portion having a width of 90% or less of its whole width between an inflow opening and an outflow opening is constructed on a planar substrate.

### CLAIM OF PRIORITY

The present application claims priority from Japanese application JP 2007-304905 filed on Nov. 26, 2007, the content of which is hereby incorporated by reference into this application.

### BACKGROUND OF THE INVENTION

1. Field of the Invention

The present invention relates to a device for sample pretreatment that has a micro-reactor formed on a planar substrate for carrying out a reaction of a microscale sample, a reactor sheet that constitutes the device for sample pretreatment, and a method of sample analysis using the device for sample pretreatment.

2. Description of the Related Art

Demand for a technique which allows high-speed treatment/measurement of a large number of samples in large-scale analysis in the field of genomics and proteomics research of recent years has been increasing. For example, a microarray technique in which a large variety of biomolecules are fixed on a substrate and a high-speed technique for sample pretreatment which uses an enzyme fixed on a substrate have been attracting attention. In these techniques, it is necessary to construct on a substrate in advance a reactor which allows a reaction between a molecule on the substrate and a sample solution added onto the substrate. Since a sample, such as blood, in many cases is obtained in minute amounts in an approximate range of several tens to several hundreds microliters, the capacity of the reactor is also required to be small. However, since an area of a certain size or larger is required for a reaction surface, the reactor necessarily needs to have a thin shape having a thickness of 1 mm or smaller. As a material of the reactor, it is desirable to use a hydrophobic material to which a biological sample is unlikely to attach. However, when a sample, which is an aqueous solution, is introduced into such a hydrophobic micro-reactor, uniform sending of the sample solution inside of the reactor is unlikely to be achieved. Accordingly, bubbles are likely to be formed inside of the reactor. In the case where a molecule to be fixed on the substrate is a biological sample, such as antibody and enzyme, it is highly possible that such a sample loses its original function when it is brought into contact with air and desiccated due to bubble entrainment. Furthermore, attachment of the reactor to the substrate is deteriorated due to bubble entrainment; therefore, it is possible that a sample is lost by leaking out from the reactor during a reaction. For these reasons, bubble entrainment is a serious problem in the above-described techniques.

As a technique for preventing bubble entrainment into a minute structure, for example, Japanese Unexamined Patent Application Publication hei 6-343694 describes a method in which one solution flow is temporarily branched into multiple fine solution flows. However, this technique aims to remove, during solution sending, bubbles which have been already contained in a sample. Accordingly, it cannot prevent bubble formation which is due to the hydrophobicity inside of a thin reactor formed on a planar substrate. Moreover, with the shape of this technique, a reaction between a molecule fixed on a planar substrate and a solution, such as carried out in a microarray experiment, cannot be carried out.

Meanwhile, Japanese Patent Application Publication 2006-189374 discloses a technique in which multiple reactors are connected with each other through a flow path of a fine tube and a solution is moved from one reactor to another reactor by using centrifugal force. In this case, connection with the use of a fine tube is adopted for the purpose of solution sending control and prevention of backward flow. However, it is not for preventing bubble entrainment into a flow path.

### SUMMARY OF THE INVENTION

An object of the present invention is to solve the problems inherent to the conventional techniques, and to provide a device for sample pretreatment which allows no bubble formation when a sample solution is introduced into the minute and hydrophobic inside of a reactor and a method of sample analysis using the device for sample pretreatment.

A device for sample pretreatment of the present invention includes: a hydrophobic micro-reactor which is constructed on a planar substrate; at both end sides of the reactor, an inflow opening that allows a sample to flow into the reactor and an outlet opening that allows air inside the reactor to escape when the sample is flowing thereinto; and at least at one portion, in which a reactor width is 80% or less of the whole width, between the inflow opening and the outlet opening. The reactor is easily attached onto the planar substrate, and is formed by attaching a sheet that has a groove to be a reactor on a lower surface of the sheet onto the planar substrate.

According to this structure, bubble formation is prevented because of a phenomenon in which a sample solution flows towards a part having a narrow reactor width in a concentrated manner at the time of the sample introduction. A sample supposed to be introduced as a target into the reactor of the present invention is typically a sample having a small volume in an approximate range from several tens to several hundreds microliters.

As the planar substrate, ones can be used are obtained by applying a modification appropriate for fixing, if necessary, to: a membrane made of nitrocellulose, PVDF, or the like; glass; silicon used as a wafer and the like; a resin, such as plastics; metal; and the like. As for a type of modification, poly-L-lysine and aminosilane that allow a biomolecule to be fixed thereon by physical adsorption; functional groups, such as an aldehyde group and an epoxy group, that allow a target molecule to be fixed thereon by covalent bonding; and avidin, Ni-NTA, and the like that allow fixing by using the affinity with a target molecule can be used. In addition, a solid phase composed of a thin layer of a hydrophilic porous matrix, such as polyacrylamide gel and agarose gel, can also be used.

As for a material for a sheet that is placed on the planar substrate to form the reactor, it is necessary to use a material that is attachable to the planar substrate and does not affect the sample. For example, polydimethylsiloxane (PDMS) is a good material because a biological sample hardly adheres to PDMS, and also PDMS is cheap and easily processed.

According to the present invention, it is possible to prevent bubble formation when a sample solution is introduced into the minute and hydrophobic inside of a reactor.

### BRIEF DESCRIPTION OF THE DRAWINGS

FIG. 1 is an explanatory view of an analytic procedure.

FIGS. 2A to 2G are schematic views of operations for analysis.

FIG. 3 is an explanatory view of shapes of reactors and bubble formation.

FIG. 4 is a manufacturing process chart of a reactor sheet.

FIGS. 5A to 5E are views illustrating an outline of a method for using a vibratory agitation unit.

FIG. 6 is a view illustrating a result of an experiment.

### DESCRIPTION OF THE PREFERRED EMBODIMENTS

Hereinafter, an embodiment of the present invention will be described.

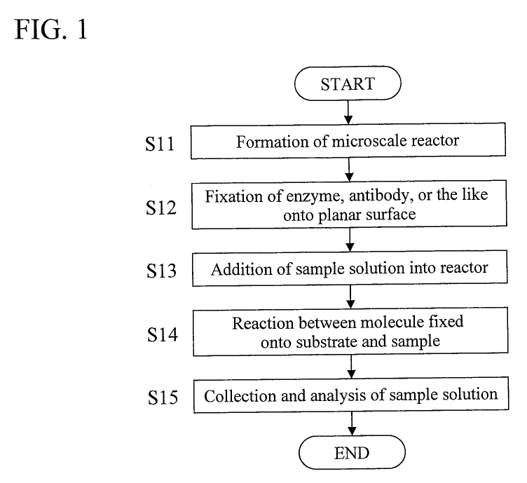

FIG. 1 is an explanatory view illustrating an analytic procedure using a device for sample pretreatment of the present invention. In the present embodiment, an operation is carried forward in an order of: formation of a microscale reactor by attaching a hydrophobic sheet onto a substrate (S11); fixing of an enzyme, an antibody, or the like onto a planar substrate (S12); addition of a sample solution to the reactor (S13); reaction between a molecule fixed onto the substrate and the sample (S14); and collection and analysis of the sample solution (S15). However, the present invention is not limited only to the present embodiment. In the present embodiment, in addition to the device for sample pretreatment, a micropipettor, a sealed container, a gas-phase incubator, and a washing container are used. Furthermore, if necessary, an agitation device (small-sized vibration motor) for agitating a sample inside of the reactor is used.

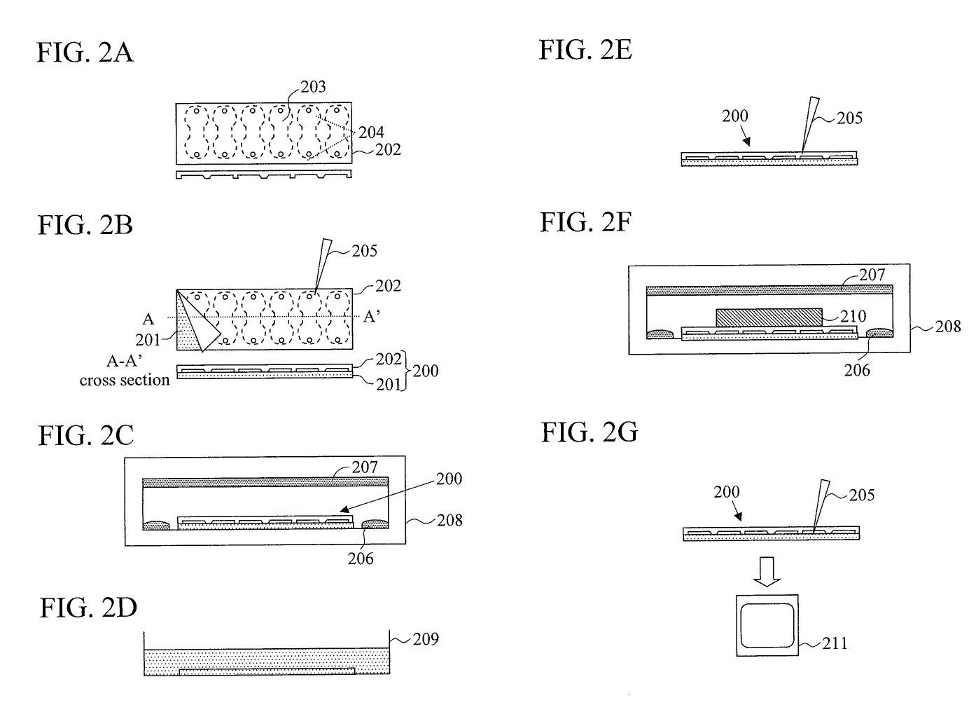

FIGS. 2A to 2G are a schematic view of operations for analysis. As shown in FIG. 2A, a reactor sheet 202 has on its lower surface six grooves 203 having a depth in a range from 0.2 to 0.5 mm formed at 3 mm intervals. By arranging the reactor sheet 202 on a planar substrate, a reactor for holding a sample and a reagent on the planar substrate can be formed. In the meantime, at both ends of the long side of the groove 203, inflow/outflow openings 204 having a diameter of 1 mm are formed for supplying and discharging a sample and a reagent to and from the reactor.

(1) Formation of a Microscale Reactor by Attaching a Reactor Sheet onto a Substrate

As shown in FIG. 2B, a device for sample pretreatment 200 that has between the planar substrate 201 and the reactor sheet 202 the reactor 203 for holding a sample and a reagent on a planar substrate 201 is formed by attaching the reactor sheet 202 having a groove of a depth in a range from 0.2 to 0.5 mm onto the planar substrate 201.

(2) Fixing of an Enzyme, an Antibody, or the Like onto a Planar Substrate

As shown in FIG. 2B, a reagent to be fixed is added to the inside of the reactor 203 formed on the planar substrate 201 of the device for sample pretreatment 200 through the inflow opening 204 by the use of a micropipettor 205. Next, as shown in FIG. 2C, the device for sample pretreatment 200 along with water droplet 206 is set inside a sealed container 207, and incubated inside a gas-phase incubator 208 so as to carry out a binding reaction onto the planar substrate 201. By sealing the device for sample pretreatment 200 inside the sealing container 207 together with a small amount of water droplet 206, the humidity inside the container 207 can be maintained for an extended period of time, and evaporation of a sample and a reagent on the planar substrate 201 can be prevented. Thereafter, as shown in FIG. 2D, after the reactor sheet 202 is detached from the device for sample pretreatment 200, the planar substrate 201 onto which the reagent is foxed is shaken in a washing container 209 filled with a washing solution so as to remove unattached molecules of the reagent.

(3) Addition of a Sample Solution into a Microscale Reactor

As shown in FIG. 2E, the reactor sheet 202 is again attached onto the planar substrate 201 so as to construct the device for sample pretreatment 200, and a sample solution, such as blood, is added through the inflow opening 204 of the reactor by the use of the micropipettor 205.

(4) Reaction Between a Molecule Fixed onto a Substrate and a Sample

As shown in FIG. 2F, while a sample is held inside the reactor 203, the device for sample pretreatment 200 is placed together with water droplet 206 in the sealed container 207, and incubated inside the gas-phase incubator 208 for a certain period of time so as to carry out a reaction between the fixed molecule of the reagent and the sample. If necessary, an agitation device (small-sized vibration motor) 210 is used for agitating the sample inside the reactor.

### (5) Collection and Analysis of a Sample Solution

As shown in FIG. 2G, the sample inside the reactor 203 of the device for sample pretreatment 200 is collected by using the micropipettor 205, and analyzed by an analyzing device 211.

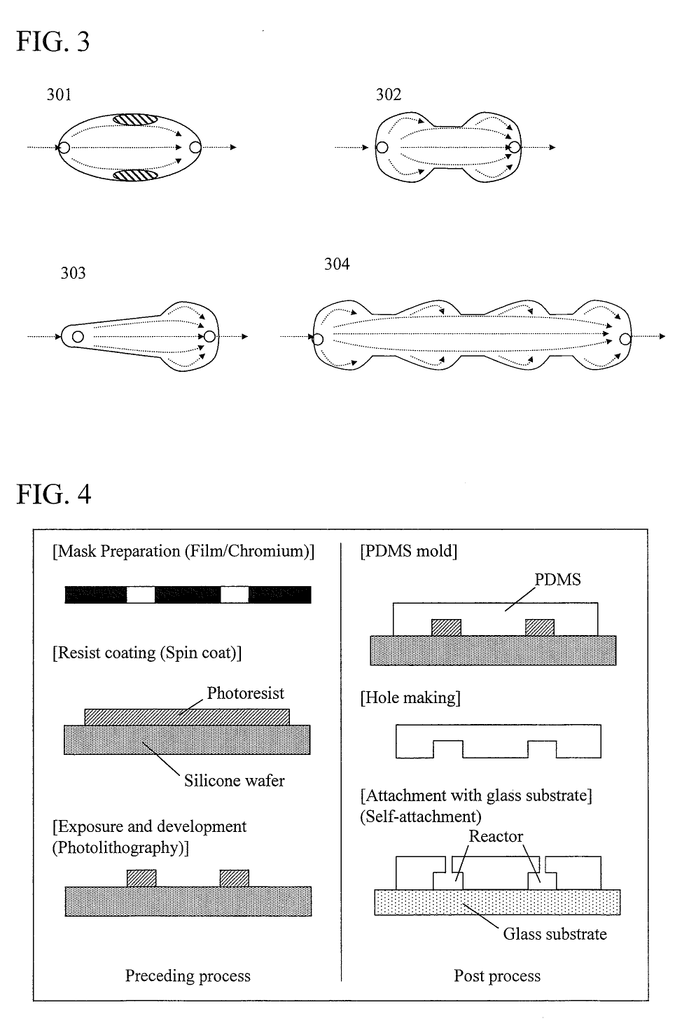

Next, by the use of FIG. 3, a shape of the reactor and bubble formation will be described. In the case where the reactor has a simple oval structure as a reactor 301, uniform solution sending inside the reactor is not achieved due to the hydrophobicity of the material of the reactor, and, especially, the solution is less likely to be sent to the vicinity of the edge (a region indicated by diagonal lines in the drawing) in a middle region which is located farthest from the inflow opening and the outflow opening. Accordingly, bubbles are likely to be formed in this region. In the meantime, as shown by a reactor 302, in the case where a reactor has a part in which a reactor width is narrow at least at one site between the inflow opening and the outflow opening, a direction of solution sending inside the reactor is to be concentrated in the part in which a reactor width is narrow. Accordingly, the above-described bubble formation can be prevented. The sizes of the bubbles are 0.5±0.1 mm. Therefore, in the case where such bubbles are formed on both edge sides of the reactor, it is possible that bubbles take up 1.6 mm at a maximum when considering a dispersion of 3σ. This is approximately 20% of the whole width of the reactor. Therefore, the width of the middle region is desirably 80% or less of the whole width.

The principle of preventing bubble formation involves controlling a direction of solution sending in the reactor. Accordingly, as for the shape, in addition to the reactor 302, an equivalent effect is also observed with a shape, as shown by a reactor 303, in which the width of the whole region near the inflow opening, that is, the left half of the reactor is narrow, and a shape, as shown by a reactor 304, in which regions having narrow widths are located in multiple sites between the inflow opening and the outflow opening. Here, arrows in the drawings indicate directions of solution sending.

The percentage of bubble formation in the case where 40 μL of an aqueous solution was introduced into the reactor 301 by the use of a micropipettor in 3 seconds was 18.3%, while the percentage of bubble formation in the case where an aqueous solution was introduced into the reactor 302 was 5%. This shows that change in the shape of the reactor is effective for preventing bubble formation.

FIG. 4 is a schematic view illustrating a manufacturing process of the reactor sheet constituting the device for sample pretreatment of the present invention. After a photoresist is coated onto a silicone wafer and a pattern is prepared by photolithography, a PDMS resin is added thereto so as to prepare a reactor sheet holding a target pattern. After forming on the reactor sheet holes corresponding an injection opening or an outflow opening, the reactor sheet is attached to a target glass substrate.

### EXPERIMENT EXAMPLE

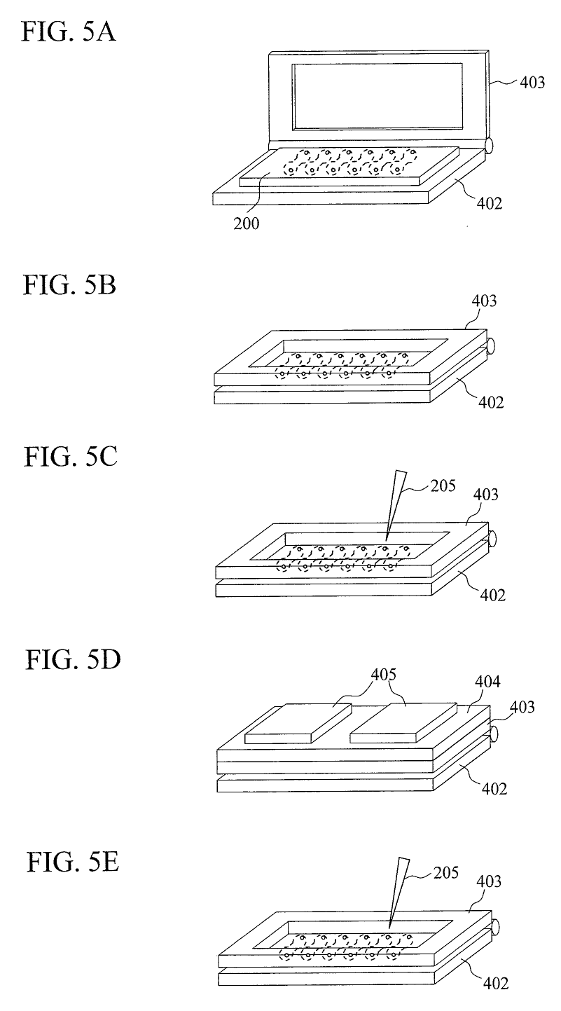

Using FIG. 5, an experiment example using a device for sample pretreatment of the present invention will be described. In the present experiment example, trypsin, which is a kind of protease, is fixed onto a planar substrate; a reactor sheet prepared by PDMS is attached onto the substrate; BSA, which is a kind of protein, is introduced into the reactor; the introduced sample is agitated inside the reactor by applying vibration; and the digestion of the sample by fixed trypsin was analyzed by HPLC.

### Reactor Sheet

The reactor sheet is a PDMS sheet having a size of 35 mm in length×85 mm in width×2 mm in thickness, and having six grooves, which serve as a reactor, formed thereon at 3 mm intervals. The groove has a structure in which two circles having a diameter of 8 mm are connected by a flow path having a width of 3.5 mm and a length of 3 mm, and the depth of the groove is 0.3 mm. The capacity of the reactor is 40 μl. At both ends of the reactor, an inflow opening and an outflow opening each of which has a diameter of 1 mm are provided for injection of a sample into the inside of the reactor.

### Vibratory Agitation Unit

The vibratory agitation unit is composed of: a holder 401 that holds a device for sample pretreatment constituted by attaching tightly a planar substrate and the reactor sheet; and a vibratory unit 404 having a vibration motor 405. The holder 401 is composed of a lower holder 402 and an upper holder 403. The upper holder 403 has a frame-like shape and an opening part, and while the upper holder 403 holds the device for sample pretreatment at the frame part, it can access the inflow opening of the reactor formed in the device for sample pretreatment through the opening part.

FIGS. 5A to 5E show an outline of a method for using the vibratory agitation unit. Firstly, as shown in FIG. 5A, after the planar substrate constituting the device for sample pretreatment is set onto the lower holder 402, the reactor sheet is placed on the planar substrate. At this time, in the device for sample pretreatment, a reactor that holds a sample is formed between the planar substrate and the groove of the reactor sheet. Next, as shown in FIG. 5B, the upper holder 403 is closed so as to attach tightly the planar substrate of the device for sample pretreatment to the reactor sheet. Next, as shown in FIG. 5C, through the opening part of the upper holder 403, a sample is injected into the inside of the reactor of the device for sample pretreatment by the use of a micropipettor 205 through the inflow opening, and then the inflow opening is sealed with a seal. Next, as shown in FIG. 5D, the vibratory unit 404 is attached thereto, and the sample is agitated by activating the motor 405. After the completion of the reaction, as shown in FIG. 5E, through the opening part of the upper holder 403, the sample is collected from the reactor by the use of the micropipettor 205.

Fixing of Trypsin onto the Planar Substrate

In the present experiment, ProteoChip (Type A, Proteogen) was used as the planar substrate. Proteochip is a protein chip in which a protein binding agent “ProLinker,” which is a kind of calyx crown derivative, onto a slide glass (26 mm in length×76 mm in width). Proteochip allows fixing of a protein onto its surface by an interaction with ProLinker.

The reactor sheet was attached onto Proteochip 201, and they were fixed with each other by the holders 402 and 403. Trypsin (T8802, SIGMA) was prepared at 1 mg/mL using PBS (pH 7.4), and injected into the inside of the reactor through the inflow opening. The inflow opening was sealed by attaching a seal, and the Proteochip 201 was left at rest at 4° C. overnight for fixing of trypsin.

Next, after the reactor sheet was detached from the ProteoChip 201 and put into a washing container 209, washing operation by 10 minute-shaking with the addition of PBS (pH 7.4) was repeated twice. Next, the ProteoChip 201 was rinsed with 10 mM Tris-HCl (pH 8.0) twice, and then residual water droplets on the ProteoChip 201 were removed by the use of a filter paper.

### Reduction and Alkylation of BSA

BSA (A9647, SIGMA) was prepared at 1 mg/mL using a denaturation buffer (200 mM Tris-HCl containing 6M guanidine chloride and 2.5 mM EDTA, pH 8.5). One microliter of a reducing solution (sterilized water containing 60 mg/mL DTT) was added to 1 mL of the protein solution. After nitrogen gas was gently blown onto the surface of the solution for 30 seconds, the solution was left at rest at 37° C. for 3 hours so as to carry out denaturation and reduction treatment of the protein. After the reaction, the solution temperature was lowered by placing the solution on ice for 5 minutes, and 20 μL of an alkylation solution (a denaturation buffer containing 50 mg/mL iodoacetamide) was added thereto. After nitrogen gas was gently blown onto the surface of the solution for 30 seconds, the solution was left at rest at room temperature under a light shielding condition for 1 hour so as to carry out alkylation of a cysteine side chain after reduction. Lastly, dialysis in 200 ml of a reaction buffer (Tris-HCl, pH 8.5) at 4° C. for 2 hours was repeated three times so as to remove guanidine chloride in the solution.

### Digestion of BSA

The reactor sheet 202 was attached onto the planar substrate on which trypsin had been fixed and they were fixed with each other by the use of the holders 402 and 403 of the vibratory agitation unit. Thereafter, BSA which had been subjected to reduction and alkylation and prepared at 0.2 mg/mL was injected into the inside of the reactor. The vibratory unit 404 was set, and then the planar substrate was subjected to 30 minute-shaking at 37° C. so as to carry out a digestion reaction.

### Analysis of a Tryptic Digest by Reverse-Phase HPLC

The digested BSA which had been collected was subjected to reverse-phase HPLC analysis, and digestion was confirmed by observing a reduction of a peak which correspond undigested BSA. Measurement conditions are described as follows.

Column: CAPCELLPAK C18 MG (2 mm in inner diameter×75 mm, 3 μm particle diameter, SHISEIDO)
Mobile phase A solution: 2% acetonitrile containing 0.1% TFA
Mobile phase B solution: 98% acetonitrile containing 0.1% TFA
Gradient: After solution sending at a percentage of solution A of 100% for 5 minutes after the initiation of the measurement, linear gradient was performed in which the percentage of solution A was reduced from 100% to 40% (the percentage of solution B was increased from 0% to 60%) over the period from the 5-minutes time point to the time point 60 minutes after the initiation of the measurement.
Flow rate: 0.2 mL/minute
Detection: absorbance at an ultraviolet region (214 nm)

### Experiment Result

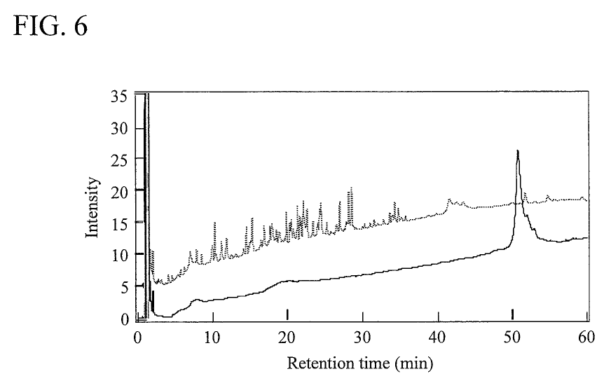

The result of HPLC analysis in the case where a reactor having the shape illustrated as 302 in FIG. 3 is used is shown in FIG. 6. Disappearance of a peak corresponding undigested BSA (solid line, retention time at 50 minute) and appearance of a peak corresponding a generated peptide (broken line, retention time from 5 to 40 minute) were observed. In the case where a reactor having the shape illustrated as 303 in FIG. 3 is used, no bubble formation occurs as well. Therefore, a similar result is obtained.

On the other hand, in the case where a reactor having the shape illustrated as 301 in FIG. 3 is used, attachment of the reactor onto the substrate was deteriorated due to bubble entrainment. Accordingly, the sample leaked from the reactor during the reaction, and analysis could not be carried out.

The present invention can be used for a reaction in a microarray experiment and a pretreatment, such as condensation of a certain molecule and enzymatic treatment, for biological molecular analysis.

### DESCRIPTION OF REFERENCE NUMERALS

201 planar substrate
202 reactor sheet
203 groove (reactor)
204 inflow opening/outflow opening
205 micropipette
206 water droplet
207 sealed container
208 incubator
209 washing container
210 agitation device (small-sized vibration motor)
211 analyzing device
402 lower holder
403 upper holder
404 vibratory unit
405 vibration motor

What is claimed is:

1. A device for sample pretreatment, comprising:
a plurality of flat reactors each having a great width relative to a height thereof and having upper, lower, and side surfaces that are surrounded by wall surfaces;
a sample injection opening formed at one end of the upper surface of each reactor; and
an outflow opening formed at an end part located at an opposite side of the sample injection opening on the upper surface of each reactor,
wherein each reactor has at least one constricted part having a width narrower than a maximum width of the reactor between the sample injection opening and the outflow opening.

2. The device for sample pretreatment according to claim 1, wherein the width of the constricted part is 80% or less of the maximum width.

3. The device for sample pretreatment according to claim 1, wherein
each reactor has an oval shape of 18 mm in long diameter and 8 mm in short diameter, and has such constricted parts respectively at intersection points of a short axis and an oval contour of the reactor as to have a width of 80% or less of the short diameter between the constricted parts.

4. The device for sample pretreatment according to claim 1, wherein the plurality of reactors are formed by attaching a sheet onto a planar substrate, the sheet having on a lower surface thereof a plurality of concave portions each having a shape of the reactor.

5. A device for sample pretreatment, comprising;
a plurality of flat reactors each having a great width relative to a height thereof and having upper, lower and side surfaces that are surrounded by wall surfaces;
a sample injection opening formed at one end of the upper surface of each reactor;
an outflow opening formed at an end part located at an opposite side of the sample injection opening on the upper surface of each reactor,
wherein each reactor has a reactor width spreading in a gradient manner from the sample injection opening towards the outflow opening.

6. A reactor sheet made of a resin and used for forming a plurality of reactors between the reactor sheet and a planar substrate by being attached onto the planar substrate, comprising:
on a lower surface thereof, a plurality of independent grooves having a great width relative to a depth thereof, the plurality of independent grooves each to be the reactor, wherein each of the grooves has: a sample injection opening and an outflow opening that go through to reach an upper surface of the reactor sheet; and at least one constricted part having a width narrower than a maximum width of the reactor between the sample injection opening and the outflow opening.

7. The reactor sheet according to claim 6, wherein a width of the constricted part is 80% or less of the maximum width.

8. The reactor sheet according to claim 6, wherein the reactor sheet is formed of a silicone rubber such as polydimethylsiloxane.

9. The reactor sheet according to claim 6, wherein a width of the reactor spreads in a gradient manner from the sample injection opening towards the outflow opening.

10. A method of sample analysis, comprising the steps of:
attaching a reactor sheet onto a planar substrate to form a plurality of reactors between the planar substrate and the reactor sheet, the reactor sheet having on a lower surface thereof a plurality of independent grooves each having: a great width relative to a depth thereof; a sample injection opening and an outflow opening that go through to reach an upper surface of the reactor sheet; and at least one constricted part having a width narrower than a maximum width between the sample injection opening and the outflow opening;
injecting a fixing reagent into each of the plurality of reactors from the sample injection opening;
detaching the reactor sheet from the planar substrate and removing unattached reagent that is not attached to the planar substrate by washing the planar substrate;
forming a plurality of reactors by again attaching the reactor sheet onto the washed planar substrate;
injecting a sample into the plurality of reactors from the sample injection opening so as to cause the sample to react with the reagent;
collecting a sample inside the plurality of reactors therefrom; and
analyzing the collected sample.

11. A method of sample analysis, comprising the steps of:
attaching a reactor sheet onto a planar substrate so as to form a plurality of reactors between the planar substrate and the reactor sheet, the reactor sheet having a width of a reactor spreading in a gradient manner from an sample injection opening towards an outflow opening;
injecting a fixing reagent into each of the plurality of reactors from the sample injection opening;
detaching the reactor sheet from the planar substrate and removing unattached reagent that is not attached to the planar substrate by washing the planar substrate;
forming a plurality of reactors by again attaching the reactor sheet onto the washed planar substrate;
injecting a sample into the plurality of reactors from the sample injection opening so as to cause the sample to react with the reagent;
collecting a sample inside the plurality of reactors therefrom; and
analyzing the collected sample.
